(19) United States
(12) Patent Application Publication
(10) Pub. No.: US 2026/0249392 A1
(43) Pub. Date: Aug. 27, 2026

(54) MULTI-PIECE NOZZLE FOR A LASER PROCESSING SYSTEM

(71) Applicant: Hypertherm, Inc., Hanover, NH (US)

(72) Inventors: Kenneth J. Woods, New London, NH (US); Marco Celeghin, Noale (IT); Joe Ciambra, Thetford Center, VT (US); James Neval Huff, JR., Braintree, VT (US); Minah Puddy Wheatley, Minneapolis, MN (US); David J. Cook, Bradford, VT (US); Paul Dominic Leonardo, Lebanon, NH (US)

(21) Appl. No.: 19/547,816

(22) Filed: Feb. 24, 2026

Related U.S. Application Data
(60) Provisional application No. 63/762,392, filed on Feb. 24, 2025.

(51) Int. Cl. B23K 26/14

(52) U.S. Cl. CPC B23K 26/1482; B23K 26/1488

(57) ABSTRACT

A nozzle for a laser processing head is provided. The nozzle includes a body defining a central longitudinal axis extending between a proximal end and a distal end. The nozzle also includes a central passage disposed in the body extending between the proximal end and the distal end along the central longitudinal axis. The central passage defines an engagement region and an alignment region located on a circumferential interior surface proximate the distal end and axially spaced from the engagement region. The nozzle further includes a replaceable nozzle bore disposed within the central passage of the body and connected to the body via the engagement region. The nozzle bore is aligned with the body via the alignment region.

### CROSS REFERENCE TO RELATED APPLICATION

This application claims the benefit of and priority to U.S. Provisional Patent Application No. 63/762,392 filed on Feb. 24, 2025, which is owned by the assignee of the instant application and is incorporated herein by reference in its entirety.

### TECHNICAL FIELD

The present invention generally relates to a multi-piece nozzle for a laser process system.

### BACKGROUND

Material processing systems such as laser processing systems, liquid jet processing systems, and plasma arc processing systems are typically used to cut or gouge materials, such as metal sheets. Frequently, laser processing systems are used in precision cutting operations due to the control provided by the laser beam, gas jet, and geometry of the laser nozzle of this type of system. Laser processing systems can generally include a high-power laser, a pressurized gas stream, an optical system, and a computer numerical control (CNC) unit.

In operation, laser processing systems use a pressurized gas stream to blow molten material away from the work area. The flow profile of the gas stream can be determined by the operating pressure and physical characteristics of the nozzle geometry. Traditionally, the gas stream includes air, oxygen, nitrogen, argon, etc. or mixtures of these various gases. The selected gas chemistry and workpiece material are adapted to have significant impact on cutting performance and results. In addition, in typical laser processing systems, the diameter of the laser beam can be approximately the same as the diameter of the nozzle orifice; therefore, to generate satisfiable cutting quality and nozzle life, the operating window (e.g., design space or flexibility for adjusting dimensions) for the beam focus and nozzle size is quite narrow.

The increase in demand for more precision in the desired cuts when using laser processing systems, especially in view of the many extreme conditions that laser nozzles are exposed to during operations (e.g., drastic thermal loads and variations, workpiece collisions, high pressure gas flows, slag and dross exposure, etc.), has led to the development of increasingly complex and intricate laser nozzle designs. Such increased complexity and tolerancing of these laser nozzles drive the improved performance and outcomes, but have also increased the manufacturing cost of creating these laser nozzles as well as having increased the cost to the operators when laser nozzles need to be replaced.

Some laser nozzle designers have attempted to reduce the cost associated with laser nozzle wear and tear by designing double nozzles with a replaceable central/inner core. During operation, the portions of a nozzle that are closest to and/or directly exposed to the laser beam (e.g., primary heat load) and primary gas flow are the quickest to degrade/lose life and can lead to a failure of the nozzle. The intent of these multi-piece nozzle designs is that several inner replaceable cores can be used in a single outer nozzle body prior to the outer nozzle body itself being exhausted. This can reduce machining costs as well as material costs with the inner core being consumed at a much higher rate and being formed from a significantly reduced diameter bar stock. However, these designs have failed in producing a small enough central/inner core insert and have struggled with alignment issues, particularly between the bore and the body of the outer nozzle. These alignment issues, particularly at the critical bore and orifice cross-sections nearest the laser beam, degrade life and cut quality in these designs.

Therefore, there is a need for more optimized multi-piece nozzle designs for laser processing systems.

### SUMMARY

The present invention features a laser nozzle with an outer nozzle body and a replaceable inner core component that includes a primary orifice of the laser nozzle. For example, the primary orifice can be an integral feature of the inner core component. The inner core component can also include at least one alignment feature proximate to its distal tip to facilitate functional alignment with the outer nozzle body and with the central longitudinal axis of the laser nozzle. In some embodiments, an internal thread connection is provided between the inner core component and the outer nozzle body for engagement (e.g., installation and removal) between the two components.

In one aspect, a method of installing a nozzle bore in a body of a laser nozzle is provided. The method includes providing the body that defines a central longitudinal axis extending between a proximal end and a distal end of the body. The body comprises a central passage extending between the proximal end and the distal end along the central longitudinal axis. The method also includes inserting the nozzle bore into the central passage of the body from the proximal end and engaging the nozzle bore to the body via respective ones of engagement regions of the nozzle bore and the central passage of the body to form an engagement interface. The engaging is adapted to distally advance the nozzle bore within the central passage along the longitudinal axis. The method further includes radially and axially aligning a distal tip of the nozzle bore with the central passage of the body as the nozzle bore distally advances within the central passage. The aligning forms an alignment interface between an external circumferential surface of the nozzle bore and an internal circumferential surface of the central passage. The alignment interface is located distal to the engagement interface along the longitudinal axis.

In some embodiments, a proximal end of the nozzle bore is aligned with the central passage of the body as the nozzle bore distally advances within the central passage. The aligning forms a second alignment interface between a second external circumferential surface of the nozzle bore and a second internal circumferential surface of the central passage. The second alignment interface is proximal to the engagement interface along the longitudinal axis.

In some embodiments, engaging the nozzle bore to the body comprises threading the nozzle bore to the central passage of the nozzle body via complementary threads disposed on the nozzle bore and in the central passage. In some embodiments, the nozzle bore is disengaged from the body at the engagement interface, the nozzle bore is removed from the body via the proximal end of the body, and a second nozzle bore is inserted into the laser nozzle body.

In some embodiments, the alignment interface further comprises an axial stop formed by the internal circumferential surface of the central passage to prevent further advancement of the distal tip of the nozzle bore and enable alignment with the nozzle bore.

In some embodiments, a fluid is conducted through a set of one or more fluid flow paths spaced circumferentially about the alignment interface between the nozzle bore and the central passage.

In another aspect, a nozzle for a laser processing head is provided. The nozzle includes a body defining a central longitudinal axis extending between a proximal end and a distal end. The proximal end is configured to operably connect the nozzle to a body of the laser processing head. The nozzle also includes a central passage disposed in the body extending between the proximal end and the distal end along the central longitudinal axis. The central passage defines an engagement region and an alignment region located on a circumferential interior surface proximate the distal end and axially spaced from the engagement region. The nozzle further includes a replaceable nozzle bore disposed within the central passage of the body and connected to the body via the engagement region. The nozzle bore is aligned with the body via the alignment region.

In yet another aspect, a nozzle body of a laser processing head is provided. The nozzle body comprises a central passage disposed in the nozzle body extending between a proximal end to a distal end of the nozzle body along a central longitudinal axis. The proximal end of the nozzle body is configured to operably connect the nozzle body to a body of the laser processing head. The nozzle body also includes an engagement region disposed on an internal circumferential surface of the central passage. The engagement region is configured to matingly engage a complementary engagement feature formed on a nozzle bore disposed within the central passage. The nozzle body further includes an alignment guide located on an internal circumferential surface of the central passage at the distal end of the nozzle body and configured to contact and align a distal tip of the nozzle bore to the body. The alignment guide is located distal to the engagement region.

In yet another aspect, a replaceable nozzle bore for a nozzle of a laser processing head is provided. The nozzle bore comprises a bore body configured to be disposed within a central passage of a nozzle core of the nozzle. The bore body defines a longitudinal axis extending between a proximal end and a distal end of the body. The nozzle bore also comprises an alignment datum formed on an external circumferential surface at the distal end of the bore body. The alignment datum is configured to contact and align with a complementary alignment region of the central passage of the nozzle core. The nozzle bore further comprises an engagement region configured to secure the nozzle bore to the nozzle core. The engagement region is disposed on the bore body proximal to the alignment datum along the longitudinal axis. The nozzle bore additionally includes a secondary alignment datum formed about the proximal end of the bore body. The secondary alignment datum is configured to contact and align with a secondary complementary alignment region of the nozzle core, and the secondary alignment datum is proximal to the engagement region along the longitudinal axis.

Any of the above aspects can include one or more of the following features. In some embodiments, the engagement region of the central passage of the nozzle body comprises one or more threads configured to engage one or more complementary threads disposed on the nozzle bore. In some embodiments, the alignment region of the central passage of the body of the nozzle comprises an axial stop configured to prevent the nozzle bore from further axial advancement within the central passage. In some embodiments, the circumferential interior surface of the alignment region of the body of the nozzle is conical for achieving alignment with the nozzle bore.

In some embodiments, the central passage of the body of the nozzle further includes a second alignment region shaped to complement a proximal alignment datum disposed on the nozzle bore. The second alignment region of the central passage is axially proximal to the engagement region of the central passage to align a proximal end of the body to the central bore. In some embodiments, the proximal alignment datum of the nozzle bore forms a tight tolerance clearance fit with the second alignment region of the body of the nozzle to limit tilting of the nozzle bore within the central passage of the body. In some embodiments, the alignment region of the central passage is distal to the engagement region of the body along the longitudinal axis, and the second alignment region of the central passage is proximal to the engagement region of the body along the longitudinal axis.

In some embodiments, the nozzle bore includes a distal alignment datum adapted to form an interface with the alignment region of the central passage. The interface can comprise one of a conical-to-hemispherical or conical-to-conical interface. In some embodiments, the distal alignment datum of the nozzle bore and the alignment region of the central passage of the body of the nozzle cooperatively form a set of one or more fluid flow paths about the interface. In some embodiments, outlets for respective ones of the set of one or more fluid flow paths are spaced circumferentially about an outer circumference of a distal tip of the nozzle bore. In some embodiments, a fluid conducted through the set of fluid flow paths is a gas.

In some embodiments, the central passage has a diameter of between about 1.2 mm and about 5 mm at a narrowest inner circumference of the central passage, and the nozzle bore has a diameter of between about 6 mm and about 12 mm at a widest outer circumference of the nozzle bore. In some embodiments, a ratio of a length of the body of the nozzle along the longitudinal axis to a length of the nozzle bore along the longitudinal axis is about 2.

In some embodiments, a proximal end of the nozzle bore is hex shaped for facilitating tool attachment. In some embodiments, a distal tip of the body of the nozzle includes a set of one or more sacrificial castellations configured to contact a workpiece for preservation of the inner body. In some embodiments, the nozzle bore is completely disposed within the body. In some embodiments, a distal tip of the nozzle bore is recessed within the central passage of the body. In some embodiments, the nozzle bore and the body are constructed from different materials.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows a cross-sectional view of an exemplary multi-piece nozzle for a laser processing head, according to some embodiments of the present invention.

FIG. 2 shows an exemplary method for assembling the multi-piece nozzle of FIG. 1, according to some embodiments of the present invention.

### DETAILED DESCRIPTION

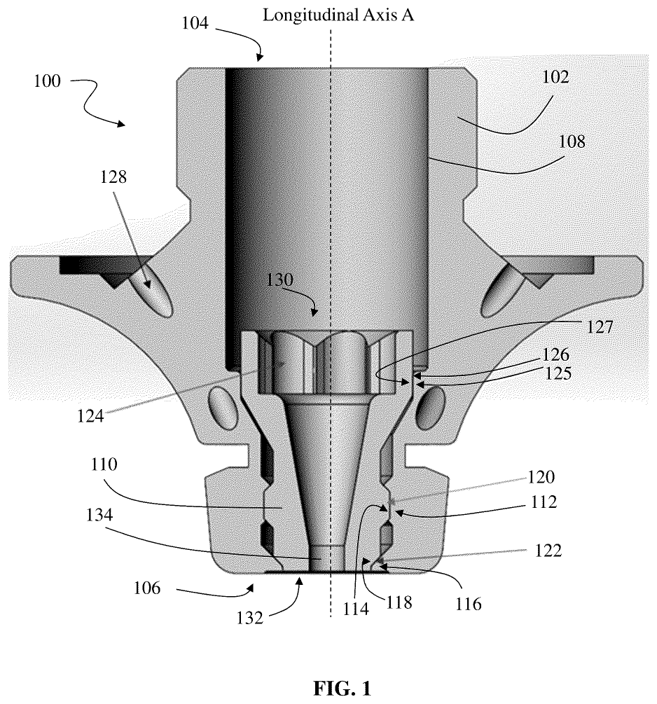

FIG. 1 shows a cross-sectional view of an exemplary multi-piece nozzle 100 for a laser processing head, according to some embodiments of the present invention. As shown, the nozzle 100 generally includes an outer body 102 defining a central longitudinal axis A extending between a proximal end 104 and a distal end 106 of the outer body 102. The distal end 106 is defined as the end that is closest to a workpiece (not shown) during an operation of the laser processing head and the proximal end 104 is disposed opposite of the distal end 106 along central longitudinal axis A and configured to connect the nozzle 100 to a body of the laser processing head (not shown). The outer body 102 also includes a central passage/orifice 108 extending between the proximal end 104 and the distal end 106 along central longitudinal axis A. In some embodiments, the central passage 108 has a diameter of between about 1.2 mm and about 5 mm at its narrowest inner circumference.

The nozzle 100 additionally includes a replaceable nozzle bore 110 disposed within the central passage 108 of the outer body 102. The nozzle bore 110 extends along the central longitudinal axis A between a proximal end 130 and a distal end 132 of the nozzle bore 110. In some embodiments, the nozzle bore 110 has a diameter of between about 6 mm and about 12 mm at its widest outer circumference. In some embodiments, the ratio of the length of the outer body 102 along the longitudinal axis A to the length of the nozzle bore 110 along the longitudinal axis A is about 2. Therefore, the nozzle bore 110 can be completely disposed within the nozzle body 102 upon assembly of the nozzle 100.

In some embodiments, the nozzle bore 110 is coupled to the outer body 102 via an engagement region located on a circumferential interior surface 112 of the outer body 102 (e.g., on the central passage 108 of the outer body 102) and a complementary engagement region located on a circumferential outer surface 114 of the nozzle bore 110. An engagement interface 120 is formed between the engagement region 112 of the outer body 102 and the engagement region 114 of the nozzle bore 110 upon assembly. In some embodiments, the engagement regions 112, 114 comprise complementary threads and the interface 120 is formed via a threaded connection.

In some embodiments, the nozzle bore 110 aligns with the outer body 102 via an alignment region located on another circumferential interior surface 116 of the outer body 102 (e.g., on the central passage 108 of the outer body 102) and a complementary alignment region located on another circumferential outer surface 118 of the nozzle bore 110. In some embodiments, the circumferential surface of the alignment region 118 of the nozzle bore 110 is circumferentially angled, such as between about 10 degrees and about 50 degrees, to contact the complementary angled circumferential surface of the alignment region 116 of the outer body 102. In some embodiments, an alignment interface 122 is formed between the alignment regions 116, 118. The alignment interface 122 can comprise a cone shape/profile on one of the outer body 102 or the nozzle bore 110 and a complementary cone or hemisphere shape/profile on the other of the outer body 102 or the nozzle bore 110, such that a substantially straight line of contact is created at the interface 122. The alignment interface 122 can comprise one of conical-to-hemispherical interface or conical-to-conical interface. For example, as shown in FIG. 1, the alignment interface 122 is shaped as a conical mating datum adjacent to the distal end 106 of the outer nozzle body 102 and the distal end 132 of the inner nozzle bore 110. In some embodiments, the alignment region 116 of the outer body 102 serves as an axial stop on the nozzle bore 110 to prevent the nozzle bore 110 from further axial advancement in the distal direction within the central passage 108 of the outer body 102, while the resulting alignment interface 122 serves to axially align the two components 102, 110. In some embodiments, alignment region 116 is located within less than about 1 centimeter of the distal end of outer body 102 and/or nozzle bore 110. In some embodiments, alignment region 116 is the last interface between outer body 102 and nozzle bore 110 along the longitudinal axis A in the distal direction where outer body 102 and nozzle bore 110 physically contact one another.

In some embodiments, as shown in FIG. 1, the nozzle bore 110 includes a set of insertion/removal features 124, such as in the form of a hexagonal shaped region, located on an outer circumferential surface adjacent to the proximal end 130 of the nozzle bore 110. The insertion/removal features 124 are configured for tool attachment during installation and/or removal of the nozzle bore 110 relative to the outer body 102 to ease threading via the engagement interface 120. In some embodiments, the insertion/removal features 124 are formed as complementary features to an insertion and/or removal tool that are shaped to matingly engage and rotationally activate/drive the inner nozzle bore 110 relative to the outer nozzle body 102. In some embodiments, an interface 126 is adapted to form between an alignment region 127 on the major diameter of the nozzle bore 110 and a corresponding alignment region 125 of the outer body 102 (i.e., a circumferential surface disposed on the central passage 108 of the outer body 102). This interface 126, which can be a cylindrical or conical interface, serves as a secondary alignment interface, in addition to the primary alignment interface 122 described above, between the two components 102, 110. In some embodiments, this secondary alignment interface 126 is a tight tolerance clearance fit to limit tilting of the nozzle bore 110 within the central passage 108 of the outer body 102, in case there is any debris present on one or more the alignment regions 118, 116 of the primary alignment interface 122 that prevents proper alignment.

As shown in FIG. 1, the primary alignment interface 122 can be located axially distal of the engagement interface 120 configured to provide means of retention between the nozzle bore 110 and the outer body 102, and the secondary alignment interface 126 can be located axially proximal of the engagement interface 120. Similarly, for the outer body 102, the alignment region 116 can be proximate the distal end 106 and axially spaced from (e.g., distal to) the engagement region 112, which is in turn spaced from (e.g., distal to) the secondary alignment region 125. For the nozzle bore 110, the alignment region 118 can be proximate the distal end 132 and axially spaced from (e.g., distal to) the engagement region 114, which is in turn spaced from (e.g., distal to) the secondary alignment region 127. In some embodiments, the engagement (e.g., threading) achieved at the engagement interface 120 serves a tertiary alignment function in addition to the primary and secondary alignment interfaces 122, 126.

In some embodiments, the distal surface on the distal end 132 of the nozzle bore 110 is axially recessed relative a distal surface on the distal end 106 of the outer body 102 such that the nozzle bore 110 at the distal end 132 is distant from and/or recessed within the outer nozzle body 102 at its distal end 106. This design allows the distal surface of the outer nozzle body 102 to endure the most damage from any workpiece scrapes generated during torch operation, thereby reducing damage to the orifice 134 of the nozzle bore 110 from which the laser beam is conducted to the workpiece. In some embodiments, the outer nozzle body 102 includes a set of collision features (not shown), such as castellations, at its distal surface that are configured to contact a workpiece or extend in the event of an accidental collision, thereby shielding the orifice 134 of the nozzle bore 110 for the purposes of collision prevention. For example, four castellations with a height of less than about 0.5 mm in the form of bumps can be disposed at the distal surface of the outer body 102 to shoulder the impact of a collision. In some embodiments, the castellations are configured as whiskers that are adapted to bend/break to allow a vision system to detect the severity of a collision.

In some embodiments, a set of circumferentially arranged and axially canted fluid flow passages 128 are disposed in the outer body 102 about the longitudinal axis A. For example, these fluid flow passages 128 can conduct water or gas therethrough. During operation of the laser nozzle 100, an assist gas can be conducted through the orifice 134 of the inner bore 100 while water can be conducted through the fluid flow passages 128 in the outer body 102 completely isolated from the assist gas such that no complex sealing within the laser nozzle 100 is required.

In some embodiments, the inner nozzle bore 110 and the outer nozzle body 102 are made from different materials each selected from brass, copper, silver, etc., to enhance robustness and functionality. In some embodiments, plating (e.g., silver plating, gold plating, layered dielectric coatings such as high reflection coatings on mirrors, etc.) is applied to one or more functional surfaces of one or both of the inner nozzle bore 110 and the outer nozzle body 102. In some embodiments, the inner nozzle bore 110 is not field serviceable, instead it is integrally connected to (e.g., crimped into) the outer nozzle body 102. As an example, the nozzle bore 110 can comprise silver (e.g., comprising greater than 80% silver) and is permanently disposed within the outer nozzle body 102 comprising copper (e.g., comprising less than 80% silver).

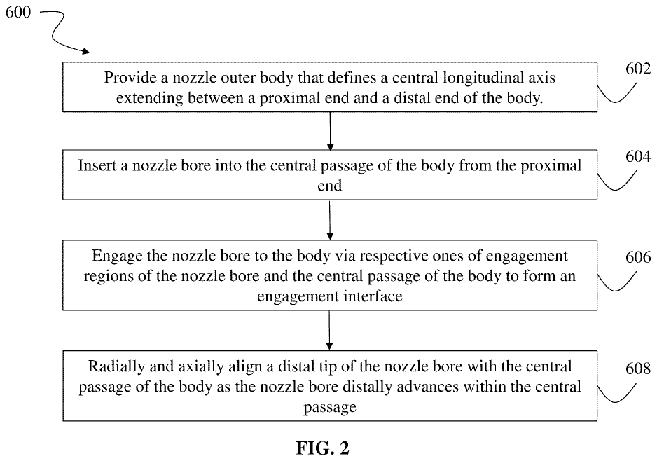

FIG. 2 shows an exemplary method 600 for assembling the multi-piece nozzle 100 of FIG. 1, according to some embodiments of the present invention. The method 600 starts at step 602 by providing nozzle body 102 of nozzle 100. At step 604, nozzle bore 110 of nozzle 100 is disposed into the central passage of the nozzle body 102 from the proximal end 104 of the nozzle body 102.

At step 606, the nozzle bore 110 is coupled/engaged to the nozzle body 102. The engagement motion can also distally advance the nozzle bore 110 within the central passage 108 of the nozzle body 102 along longitudinal axis A. For nozzle 100, this can be achieved by engaging (e.g., threading or crimping) engagement region 114 of the nozzle bore 102 with engagement region 112 on the central passage 108 of the nozzle body 102 to form an engagement interface 120.

At step 608, as the nozzle bore 110 advances distally in the central passage 108 of the outer body 102, the distal tip of the nozzle bore 110 is adapted to radially and axially align with the central passage of the outer body 102. Such alignment creates an alignment interface 122 for nozzle 100 between an external circumferential surface of the nozzle bore 110 and an internal circumferential surface of the central passage 108 of the outer body 102. The resulting alignment interface 122 is distal relative to the engagement interface 114 along longitudinal axis A. In some embodiments, the alignment interface 122 further includes an axial stop formed by an internal circumferential surface of the central passage 108 to prevent further advancement of the distal tip of the nozzle bore 110 while enabling alignment.

For nozzle 100 of FIG. 1, a proximal end of the nozzle bore 110 is further aligned with the central passage 108 as the nozzle bore 110 distally advances within the central passage 108. This proximal alignment forms the secondary alignment interface 126. In this configuration, the secondary alignment interface 126 is proximal to the engagement interface 120, while the primary alignment interface 122 is distal to the engagement interface 120.

For nozzle 100 of FIG. 1, the nozzle bore 110 can be easily replaced by first disengaging the nozzle bore 110 from the outer body 102 at the engagement interface 120, then removing the nozzle bore 110 from the central passage 108 of the outer body 102 via its proximal end 104, and finally inserting a second nozzle bore into the outer body 102 via the proximal end 104.

As discussed herein, embodiments of the invention provide low-cost laser nozzles, where each laser nozzle has a replaceable inner bore (e.g., bore 110 of nozzle 100) that has distal alignment features/locating datum (e.g., primary alignment region 118 of nozzle 100) proximal to the distal end of the nozzle to improve functional alignment. In addition, embodiments of the invention combine manufacturing techniques and tolerances across multiple nozzle components to create a robust and cost-efficient laser nozzle that meets specification and performs optimized laser processes with longer life and/or replaceable components. For example, traditionally a laser nozzle is machined instead of forged because of the tolerance requirements, small sizes of the orifice, and low roughness on the inner bore; in contrast, the multi-piece nozzles of the present invention allows different techniques for forming different pieces/components of a nozzle, such as allowing the outer bodies to be forged and the inner bores to be cold formed, both of which are low cost manufacturing methods that meet functional requirements when combined. Furthermore, for each laser nozzle, the replaceable inner bore (e.g., bore 110) can be formed with different material properties (e.g., silver, gold, chromium, etc.) than the material properties (e.g., copper) of the outer nozzle body (e.g., nozzle body 102 of nozzle 100) of the laser nozzle. In some embodiments, a highly reflective plating is formed on the inner nozzle bore. Overall, the present invention offers reduction in system operating cost (e.g., nozzle consumption) with design complexities and bar stock diameter being driven to the nozzle body that can operate with several nozzle bores before needing replacement.

It should be understood that various aspects and embodiments of the invention can be combined in various ways. Based on the teachings of this specification, a person of ordinary skill in the art can readily determine how to combine these various embodiments. Modifications may also occur to those skilled in the art upon reading the specification.

What is claimed is:

1. A nozzle for a laser processing head, the nozzle comprising:
a body defining a central longitudinal axis extending between a proximal end and a distal end, the proximal end configured to operably connect the nozzle to a body of the laser processing head,
a central passage disposed in the body extending between the proximal end and the distal end along the central longitudinal axis, the central passage defining an engagement region and an alignment region located on a circumferential interior surface proximate the distal end and axially spaced from the engagement region; and
a replaceable nozzle bore disposed within the central passage of the body and connected to the body via the engagement region, the nozzle bore being aligned with the body via the alignment region.

2. The nozzle of claim 1, wherein the engagement region of the central passage comprises one or more threads configured to engage one or more complementary threads disposed on the nozzle bore.

3. The nozzle of claim 1, wherein the alignment region of the central passage comprises an axial stop configured to prevent the nozzle bore from further axial advancement within the central passage.

4. The nozzle of claim 1, wherein the circumferential interior surface of the alignment region of the body is conical for achieving alignment with the nozzle bore.

5. The nozzle of claim 1, wherein the nozzle bore includes a distal alignment datum adapted to form an interface with the alignment region of the central passage.

6. The nozzle of claim 5, wherein the interface comprises a conical-to-hemispherical or conical-to-conical interface.

7. The nozzle of claim 5, wherein the distal alignment datum of the nozzle bore and the alignment region of the central passage of the body cooperatively form a set of one or more fluid flow paths about the interface.

8. The nozzle of claim 7, wherein outlets for respective ones of the set of one or more fluid flow paths are spaced circumferentially about an outer circumference of a distal tip of the nozzle bore.

9. The nozzle of claim 7, wherein a fluid conducted through the set of fluid flow paths is a gas.

10. The nozzle of claim 1, wherein the central passage further includes a second alignment region shaped to complement a proximal alignment datum disposed on the nozzle bore, the second alignment region of the central passage being axially proximal to the engagement region of the central passage to align a proximal end of the body to the central bore.

11. The nozzle of claim 10, wherein the proximal alignment datum of the nozzle bore forms a tight tolerance clearance fit with the second alignment region of the body to limit tilting of the nozzle bore within the central passage of the body.

12. The nozzle of claim 10, wherein the alignment region of the central passage is distal to the engagement region of the body along the longitudinal axis, and the second alignment region of the central passage is proximal to the engagement region of the body along the longitudinal axis.

13. The nozzle of claim 1, wherein a proximal end of the nozzle bore is hex shaped for facilitating tool attachment.

14. The nozzle of claim 1, wherein the central passage has a diameter of between about 1.2 mm and about 5 mm at a narrowest inner circumference of the central passage, and the nozzle bore has a diameter of between about 6 mm and about 12 mm at a widest outer circumference of the nozzle bore.

15. The nozzle of claim 1, wherein a ratio of a length of the body along the longitudinal axis to a length of the nozzle bore along the longitudinal axis is about 2.

16. The nozzle of claim 1, wherein a distal tip of the body includes a set of one or more castellations configured to contact a workpiece while protecting the nozzle bore.

17. The nozzle of claim 1, wherein the nozzle bore and the body are constructed from different materials.

18. The nozzle of claim 1, wherein the nozzle bore is completely disposed within the body.

19. The nozzle of claim 1, wherein a distal tip of the nozzle bore is recessed within the central passage of the body.

20. A method of installing a nozzle bore in a body of a laser nozzle, the method comprising:
providing the body that defines a central longitudinal axis extending between a proximal end and a distal end of the body, the body comprising a central passage extending between the proximal end and the distal end along the central longitudinal axis;
inserting the nozzle bore into the central passage of the body from the proximal end;
engaging the nozzle bore to the body via respective ones of engagement regions of the nozzle bore and the central passage of the body to form an engagement interface, the engaging adapted to distally advance the nozzle bore within the central passage along the longitudinal axis; and
radially and axially aligning a distal tip of the nozzle bore with the central passage of the body as the nozzle bore distally advances within the central passage, the aligning forming an alignment interface between an external circumferential surface of the nozzle bore and an internal circumferential surface of the central passage, wherein the alignment interface is located distal to the engagement interface along the longitudinal axis.

21. The method of claim 20, further comprising aligning a proximal end of the nozzle bore with the central passage of the body as the nozzle bore distally advances within the central passage, the aligning forming a second alignment interface between a second external circumferential surface of the nozzle bore and a second internal circumferential surface of the central passage, wherein the second alignment interface is proximal to the engagement interface along the longitudinal axis.

22. The method of claim 20, further comprising:
disengaging the nozzle bore from the body at the engagement interface;
removing the nozzle bore from the body via the proximal end of the body; and
inserting a second nozzle bore into the laser nozzle body.

23. The method of claim 20, wherein engaging the nozzle bore to the body comprises threading the nozzle bore to the central passage of the nozzle body via complementary threads disposed on the nozzle bore and in the central passage.

24. The method of claim 20, wherein the alignment interface further comprises an axial stop formed by the internal circumferential surface of the central passage to prevent further advancement of the distal tip of the nozzle bore while configured for alignment with the nozzle bore.

25. The method of claim 20, further comprising conducting a fluid through a set of one or more fluid flow paths spaced circumferentially about the alignment interface between the nozzle bore and the central passage.

26. A nozzle body of a laser processing head, the nozzle body comprising:
a central passage disposed in the nozzle body extending between a proximal end to a distal end of the nozzle body along a central longitudinal axis, the proximal end of the nozzle body configured to operably connect the nozzle body to a body of the laser processing head;
an engagement region disposed on an internal circumferential surface of the central passage, the engagement region configured to matingly engage a complementary engagement feature formed on a nozzle bore disposed within the central passage; and
an alignment guide located on an internal circumferential surface of the central passage at the distal end of the nozzle body and configured to contact and align a distal tip of the nozzle bore to the body,
wherein the alignment guide is located distal to the engagement region.

27. The nozzle body of claim 26, further comprising a second alignment guide located on a second internal circumferential surface of the central passage and configured to contact and align a proximal end of the nozzle bore relative to the body, wherein the second alignment guide is located proximal to the engagement region.

28. The nozzle body of claim 26, wherein the internal circumferential surface defining the alignment guide is conical for achieving alignment with the distal tip of the nozzle bore.

29. The nozzle body of claim 26, wherein the central passage has a diameter of between about 1.2 mm and about 5.5 mm at a narrowest inner circumference of the central passage.

30. The nozzle body of claim 26, wherein the engagement region of the central passage comprises one or more threads configured to engage one or more complementary threads disposed on the nozzle bore.

31. The nozzle body of claim 26, wherein the alignment guide of the central passage comprises an axial stop for the nozzle bore.

32. A replaceable nozzle bore for a nozzle of a laser processing head, the nozzle bore comprising:
a bore body configured to be disposed within a central passage of a nozzle core of the nozzle, the body defining a longitudinal axis extending between a proximal end and a distal end of the body;
an alignment datum formed on an external circumferential surface at the distal end of the bore body, the alignment datum configured to contact and align with a complementary alignment region of the central passage of the nozzle core;
an engagement region configured to secure the nozzle bore to the nozzle core, the engagement region disposed on the bore body proximal to the alignment datum along the longitudinal axis, and
a secondary alignment datum formed about the proximal end of the bore body, the secondary alignment datum configured to contact and align with a secondary complementary alignment region of the nozzle core, wherein the secondary alignment datum is proximal to the engagement region along the longitudinal axis.

33. The replaceable nozzle bore of claim 32, wherein the engagement region comprises one or more threads configured to engage one or more complementary threads disposed in the central passage of the nozzle core.

34. The replaceable nozzle bore of claim 32, wherein the external circumferential surface of the alignment datum is conical for achieving alignment with the nozzle core.

35. The replaceable nozzle bore of claim 32, wherein the bore body has a diameter of between about 6 mm and about 12 mm at a widest outer circumference of the bore body.
